(19) United States
(12) Patent Application Publication
(10) Pub. No.: US 2005/0034569 A1
(43) Pub. Date: Feb. 17, 2005

(54) Socket for tightening, loosening or holding a hexagonal part underneath an equally sized hexagonal nut

(76) Inventor: John K. Junkers, Saddle River, NJ (US)

Correspondence Address: STRIKER, STRIKER & STENBY, 103 East Neck Road, Huntington, NY, 11743, US

(21) Appl. No.: 10/785,325

(22) Filed: Feb. 24, 2004

Related U.S. Application Data
(63) Continuation-in-part of application No. 10/639,114, filed on Aug. 12, 2003.

(51) Int. Cl. B25B 13/06

(52) U.S. Cl. 81/121.1

(57) ABSTRACT

A socket for tightening, loosening or holding a hexagonal part underneath a substantially equally sized hexagonal nut has a socket body having an axial portion to be applied on the hexagonal part, the axial portion having an inner opening provided with six radially outwardly extending recesses each having, as considered in a circumferential direction, at least one flank adapted to interact with at least one side of the hexagonal part, the recesses being formed so that the portion of the socket body can be axially fitted over the hexagonal nut not only when sides of the hexagonal part coincide with sides of the hexagonal nut, but also when the sides of the hexagonal part are circumferentially offset from the sides of the hexagonal nut.

### CROSS-REFERENCE TO A RELATED APPLICATION

This reference is a continuation-in-part of patent application Ser. No. 10/639,114.

### BACKGROUND OF THE INVENTION

The present invention relates to sockets, and in particular to sockets for tightening, loosening or holding a hexagonal part underneath an equally sized hexagonal nut.

It is known to use one socket for turning one part of a threaded connector, for example a nut, and to use another socket for holding the other part of the threaded connector, for example a washer or a bottom nut so as to counteract the reaction forces, as disclosed for example in our U.S. Pat. Nos. 5,499,558; 6,253,642; 6,254,322; 6,254,323; 6,230,589; 6,461,093; 6,490,952. When the top nut and also the bottom nut or the washer have the same hexagonal outer surfaces, in many instances it is difficult to apply the socket with the inner hexagonal opening onto the bottom nut or the washer because the hexagonal profile of the top nut can be circumferentially offset relative to the hexagonal outer profile or the bottom nut or the washer. The top nut on the one hand and the bottom nut or the washer on the other hand must be turned relative to one another so that on the top view their outer hexagonal profiles coincide with one another, which is not easy to achieve.

### SUMMARY OF THE INVENTION

Accordingly, it is an object of the present invention to provide sockets for tightening, loosening or holding a hexagonal part underneath an equally sized hexagonal nut, which eliminates the disadvantages of the prior art.

In keeping with these objects and with others which will become apparent hereinafter, one feature of the present invention resides, briefly stated, in a socket for tightening, loosening or holding a hexagonal part underneath a substantially equally sized hexagonal nut, comprising a socket body having an axial portion to be applied on the hexagonal part, said axial portion having an inner opening provided with six radially outwardly extending recesses each having, as considered in a circumferential direction, at least one flank adapted to interact with at least one side of the hexagonal part, said recesses being formed so that said portion of said socket body can be axially fitted over the hexagonal nut not only when sides of the hexagonal part coincide with sides of the hexagonal nut, but also when the sides of the hexagonal part are circumferentially offset from the sides of the hexagonal nut.

When the socket is designed in accordance with the present invention, then even if the top hexagonal nut and the bottom hexagonal part are circumferentially offset relative to one another, it is still possible to apply the socket by axially moving it overthe top nut and then overthe bottom part, so that in the final position the inner opening with the recesses of the socket surrounds the hexagonal outer profile of the bottom part.

In accordance with anotherfeature of the present invention the opening with the recesses in the portion of the socket body has six radially inner tips and twelve radially outer tips, and each of said recesses has a radially outer surface extending between two neighboring ones of the radially outer tips.

In accordance with still a furtherfeature of the present invention the opening with the recesses has a shape which substantially corresponds to a shape of an opening with twelve recesses, in which each second inwardly extending tip is removed.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a cross-section of a torque wrench with sockets for tightening and loosening of a threaded connector;

FIG. 2 is a section taken along the line 1-1 FIG. 1 and showing a holding socket in engagement with a bottom part, such as a bottom nut or a washer in a tightening mode;

FIG. 3 is a view substantially corresponding to the view of FIG. 2 but additionally showing a top nut which blocks the holding socket from removal in an axial direction; and

FIG. 4 is a view substantially corresponding to the view of FIG. 3 in which the holding socket is turned so that the top nut no longer blocks the holding socket.

### DESCRIPTION OF THE PREFERRED EMBODIMENTS

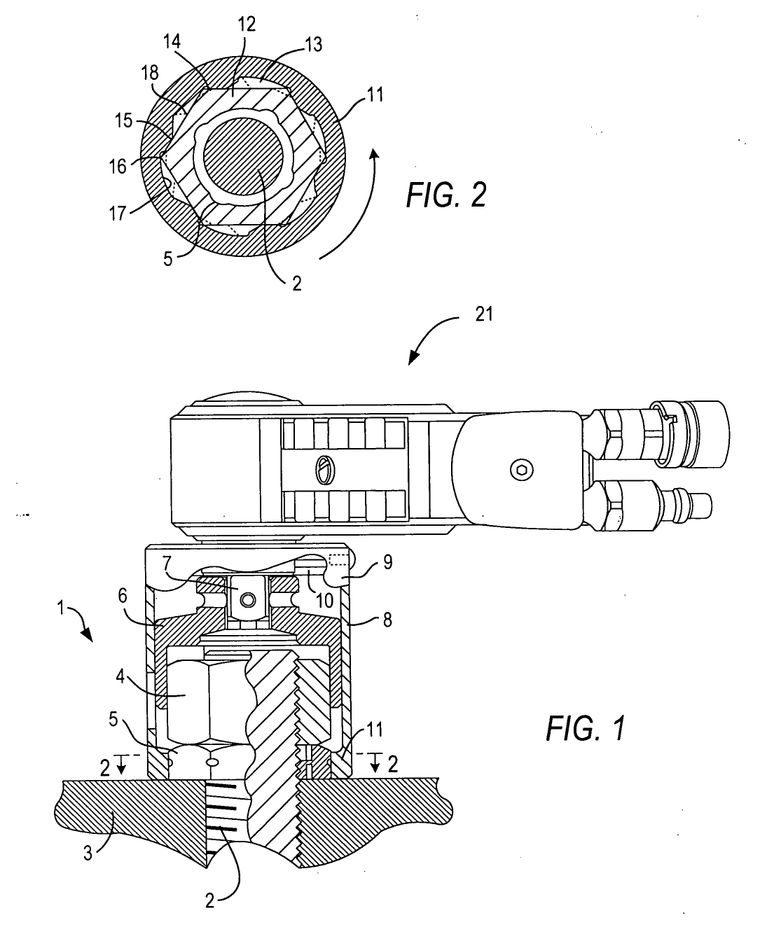

FIG. 1 shows as an example a threaded connector which is identified as a whole with reference numeral 1, and a tool for tightening or loosening the threaded connector which is as identified with reference numeral 21.

The threaded connector has a bolt 2 which is introduced in an object 3 composed for example of two parts to be connected with one another, a hexagonal nut 4 which is screwed on the bolt, and a hexagonal part such as a washer or a bottom nut 5 which is located underneath the nut 4 and between the nut 4 and the surface of the object 3. The hexagonal nut 4 and the hexagonal part 5 are substantially equally sized. The bottom nut or the washer 5 can have an inner surface engaged in the threads of the bolt 2.

The nut 4 is turnable by the tool 21 through a driving socket 6 which has a lower axial portion provided with an inner hexagonal opening substantially corresponding to the outer hexagonal profile of the nut 4 and an upper axial portion which is connected to a rotary shaft 7 of the tool 21. Therefore when the rotary shaft 7 is turned by the tool 21, the driving socket 6 is turned and turns the nut 4 on the bolt 2. During turning of the nut 4, a reaction force is produced in the bolt 2 and also in the bottom nut or the washer 5 which is connected with the bolt 2.

In order to counteract the reaction force a holding socket 8 is provided. The holding socket 8 has an upper axial portion 9 which is connected, for example by splines or the like, to an immovable part 10 of the tool 21 and surrounds the rotatable shaft 7. The holding socket 8 has a lower axial portion 11 which is located in the region of the bottom part, such as the bottom nut or the washer 5, and non-rotatably holds the bottom nut or the washer 5. It prevents turning of the bolt 2 and to counteract the reaction forces. When the holding socket 8 holds with its portion 11 the bottom nut or the washer 5 so that the later can not turn, the bolt 2 also can not turn, but only displaces in an axial direction.

FIG. 2 shows a cross-section of the axial portion 11 of the holding socket 8. It has an inner opening 12 with a plurality of recesses 13 each having at least one flank 14 formed to abut against at least one side of the outer hexagonal profile of the bottom nut orwasher 5. The inner opening 12 with the recesses 13 has six radially inner points 15 and twelve outer points 16. Each recess has an outer surface 17 extending between two neighboring radially outer points 16. In other words, the inner surface of the opening 12 with the recess 13 is actually formed as a conventional surface with sixteen inner recesses (16 point) surface in which each second radially inner point 18 is removed.

The outer surface of the inner opening 12 with the recesses 13 of the portion 11 of the holding socket 8 is formed so that the holding socket 8 can be placed on the outer hexagonal contour of the bottom nut or the washer 5 not only when the flanks 14 coincides with the corresponding sides of the hexagonal outer profile of the bottom nut or the washer 5 as shown in FIG. 2, but also when the flanks 14 are offset in a circumferential direction relative to the corresponding sides of the outer hexagonal profile of the bottom nut or washer 5. As a result, the holding socket 8 can be axially moved over the top nut 4 and the lower nut or the washer 5 also when the outer hexagonal profiles of the top nut 4 and the bottom nut or washer 5 are circumferentially offset relative to one another.

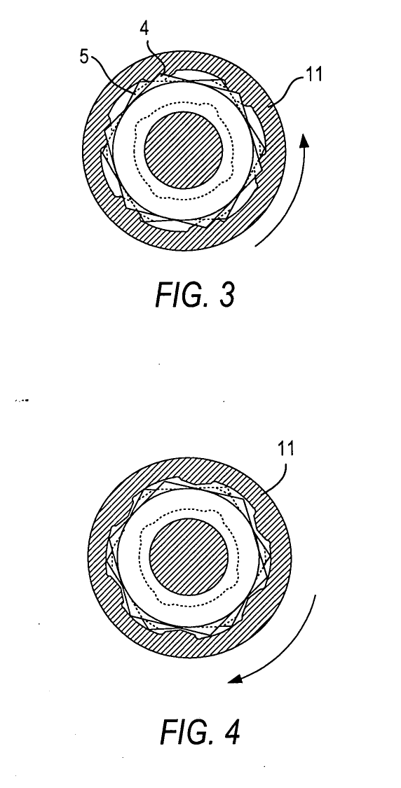

FIG. 2 shows the holding socket 8 during tightening, when the flanks 14 of the opening of the portion 1 1 of the holding socket 8 abut against the side surfaces of the hexagonal bottom nut or washer 5. FIG. 3 substantially corresponds to FIG. 2 and additionally shows a view from above on the top nut 4. It can be seen from FIG. 3 that when the threaded connector is tightened, it is possible that the top nut 4 does not allow an axial upward removal of the portion 11 of the holding socket 8, since it overlaps the radially inwardly extending points of the portion 11 of the holding socket 8. In order to remove the holding socket 8, it must be turned as shown in FIG. 4 so that the points of the top nut 4 are located in the areas of the recesses 13 of the holding socket, and thereafter the holding socket 8 can be pulled axially upwardly and removed from the bottom nut or washer 5 and from the top nut 4.

It is believed to be clear that while in the shown embodiment the holding socket 8 is designed in accordance with the present invention, the driving socket 6 can be designed in the same way, with the inner opening and recesses formed in accordance with the present invention.

It will be understood that each of the elements described above, or two or more together, may also find a useful application in other types of constructions differing from the types described above.

While the invention has been illustrated and described as embodied in socket for tightening or loosening threaded fasteners, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

1. A socket for tightening, loosening or holding a hexagonal part underneath a substantially equally sized hexagonal nut, comprising a socket body having an axial portion to be applied on the hexagonal part, said axial portion having an inner opening provided with six radially outwardly extending recesses each having, as considered in a circumferential direction, at least one flank adapted to interact with at least one side of the hexagonal part, said recesses being formed so that said portion of said socket body can be axially fifted over the hexagonal nut not only when sides of the hexagonal part coincide with sides of the hexagonal nut, but also when the sides of the hexagonal part are circumferentially offset from the sides of the hexagonal nut.

2. A socket as defined in claim 1, wherein said opening with said recesses in said portion of said socket body has six radially inner points and twelve radially outer points, each of said recesses having a radially outer surface extending between two neighboring ones of said radially outer points.

3. A socket as defined in claim 2, wherein said opening with said recesses has a shape which substantially corresponds to a shape of an opening with twelve points, in which each second inwardly extending point is removed.

4. A socket as defined in claim 1, wherein said socket body has another axial portion which is spaced from said first mentioned axial portion and is provided with means for connecting to a tool for tightening or loosening the threaded connector.
